(19) United States
(12) Patent Application Publication
(10) Pub. No.: US 2024/0004053 A1
(43) Pub. Date: Jan. 4, 2024

(54) WIRELESS COMMUNICATION METHODS, WIRELESS COMMUNICATION SYSTEMS, AND RELAY DEVICES

(71) Applicant: NIPPON TELEGRAPH AND TELEPHONE CORPORATION, Tokyo (JP)

(72) Inventors: Riku OMIYA, Musashino-shi, Tokyo (JP); Masashi IWABUCHI, Musashino-shi, Tokyo (JP); Tomoki MURAKAMI, Musashino-shi, Tokyo (JP); Tomoaki OGAWA, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/038,577

(22) PCT Filed: Dec. 2, 2020
(86) PCT No.: PCT/JP2020/044910

§ 371 Date: May 24, 2023

(51) Int. Cl. G01S 13/46; G01S 13/89; H04B 7/14

(52) U.S. Cl. CPC G01S 13/46; G01S 13/89; H04B 7/14

(57) ABSTRACT

A wireless communication method according to an embodiment includes: capturing an image by each of relay devices; detecting a position of a person captured in the image on the basis of the image captured by each of the relay devices; determining whether or not a propagation path between a radiation unit and a wireless terminal is in a line of sight on the basis of the detected position of the person and the compass information transmitted by the wireless terminal; measuring each of strengths of radio waves transmitted by the wireless terminal each time the radiation unit changes a direction in which the radio waves are radiated; selecting the relay device in which the propagation path between the radiation unit and the wireless terminal is in the line of sight on the basis of each piece of line-of-sight information indicating a result of the determination; specifying, for each of the relay devices, a direction in which radio waves radiated by the radiation unit are strongest on the basis of each piece of strength information indicating each of measured strengths of radio waves; and performing control such that the wireless terminal and the base station perform wireless communication using radio waves radiated by the selected relay device in the specified direction.

### TECHNICAL FIELD

The present invention relates to a wireless communication method, a wireless communication system, and a relay device.

### BACKGROUND ART

In wireless communication systems using high frequency bands, for example, relay devices that reflect radio waves between a base station and a wireless terminal and relays communication are known. Some relay devices include a dynamic reflector capable of controlling a phase of incoming waves when reflecting radio waves. A relay device including a dynamic reflector can expand a range in which wireless communication can be performed by changing the reflection direction of the radio waves.

In addition, Patent Literature 1 discloses a technique of capturing an image indicating a situation around a base station by a camera and determining the presence or absence of a shield that degrades wireless communication between the base station and a user terminal.

### CITATION LIST

### Patent Literature

Patent Literature 1: Japanese Patent No. 6534641

### SUMMARY OF INVENTION

### Technical Problem

However, when a human (person) holds and uses the wireless terminal, radio waves may be blocked depending on the orientation of the human body. That is, even if the relay device radiates radio waves toward the wireless terminal, there is a problem that the radio waves do not sufficiently reach the wireless terminal because the human body blocks the radio waves.

The present invention has been made in view of the above-described problems, and an object of the present invention is to provide a wireless communication method, a wireless communication system, and a relay device capable of preventing a human body from blocking radio waves from a wireless terminal used by a person.

### Solution to Problem

According to one aspect of the present invention, there is provided a wireless communication method in which a plurality of relay devices relay radio waves transmitted by a base station toward a wireless terminal capable of transmitting compass information while a person is looking at a display screen, the wireless communication method including: a radiation step in which each of the relay devices radiates radio waves while changing a radiation direction of the radio waves with a radiation unit configured to make the radiation direction variable; an imaging step of capturing an image by each of the relay devices; a detection step of detecting a position of a person captured in the image on the basis of the image captured by each of the relay devices; a determination step of determining whether or not a propagation path between the radiation unit and the wireless terminal is in a line of sight on the basis of the detected position of the person and the compass information transmitted by the wireless terminal; a measurement step of measuring each of strengths of radio waves transmitted by the wireless terminal each time the radiation unit changes the direction in which the radio waves are radiated; a selection step of selecting the relay device in which the propagation path between the radiation unit and the wireless terminal is in the line of sight on the basis of each piece of line-of-sight information indicating a result of the determination; a direction specifying step of specifying, for each of the relay devices, a direction in which radio waves radiated by the radiation unit are strongest on the basis of each piece of strength information indicating each of measured strengths of radio waves; and a control step of performing control such that the wireless terminal and the base station perform wireless communication using radio waves radiated by the selected relay device in the specified direction.

Further, according to one aspect of the present invention, there is provided a wireless communication system in which a plurality of relay devices relay radio waves transmitted by a base station toward a wireless terminal capable of transmitting compass information while a person is looking at a display screen, in which each of the relay devices includes: a radiation unit configured to make a direction in which radio waves are radiated variable; an imaging unit configured to capture an image; a detection unit configured to detect a position of a person captured in the image on the basis of the image captured by the imaging unit; a determination unit configured to determine whether or not a propagation path between the radiation unit and the wireless terminal is in a line of sight on the basis of the position of the person detected by the detection unit and the compass information transmitted by the wireless terminal; a measurement unit configured to measure each of strengths of radio waves transmitted by the wireless terminal each time the radiation unit changes the direction in which the radio waves are radiated; and a transmission unit configured to transmit, to the base station, line-of-sight information indicating a result determined by the determination unit and strength information indicating each of the strengths of the radio waves measured by the measurement unit, and the base station includes a reception unit configured to receive the line-of-sight information and the strength information from each of the relay devices; a selection unit configured to select the relay device in which the propagation path between the radiation unit and the wireless terminal is in the line of sight on the basis of each piece of the line-of-sight information received by the reception unit; a direction specifying unit configured to specify, for each of the relay devices, a direction in which radio waves radiated by the radiation unit are strongest on the basis of each piece of the strength information received by the reception unit; and a control unit configured to perform control such that the wireless terminal and the base station perform wireless communication using radio waves radiated by the relay device selected by the selection unit in the direction specified by the direction specifying unit.

Further, according to one aspect of the present invention, there is provided a relay device that relays radio waves transmitted by a base station toward a wireless terminal capable of transmitting compass information while a person is looking at a display screen, the relay device including: a radiation unit configured to make a direction in which radio waves are radiated variable; an imaging unit configured to capture an image; a detection unit configured to detect a position of a person captured in the image on the basis of the image captured by the imaging unit; a determination unit configured to determine whether or not a propagation path between the radiation unit and the wireless terminal is in a line of sight on the basis of the position of the person detected by the detection unit and the compass information transmitted by the wireless terminal; a measurement unit configured to measure each of strengths of radio waves transmitted by the wireless terminal each time the radiation unit changes the direction in which the radio waves are radiated; and a transmission unit configured to transmit, to the base station, line-of-sight information indicating a result determined by the determination unit and strength information indicating each of the strengths of the radio waves measured by the measurement unit.

### Advantageous Effects of Invention

According to the present invention, it is possible to prevent the human body from blocking radio waves from the wireless terminal used by the person.

### BRIEF DESCRIPTION OF DRAWINGS

FIG. 1 is a diagram schematically illustrating a configuration example of a wireless communication system according to an embodiment.

FIG. 2 is a functional block diagram illustrating functions of a relay device according to the embodiment.

FIG. 3 is a functional block diagram illustrating functions of a base station.

FIG. 4 is a flowchart illustrating an operation example of the relay device according to the embodiment.

FIG. 5 is a flowchart illustrating an operation example of the base station.

FIG. 6 is a flowchart illustrating an operation example in a case where the relay device according to the embodiment is a repeater.

### DESCRIPTION OF EMBODIMENTS

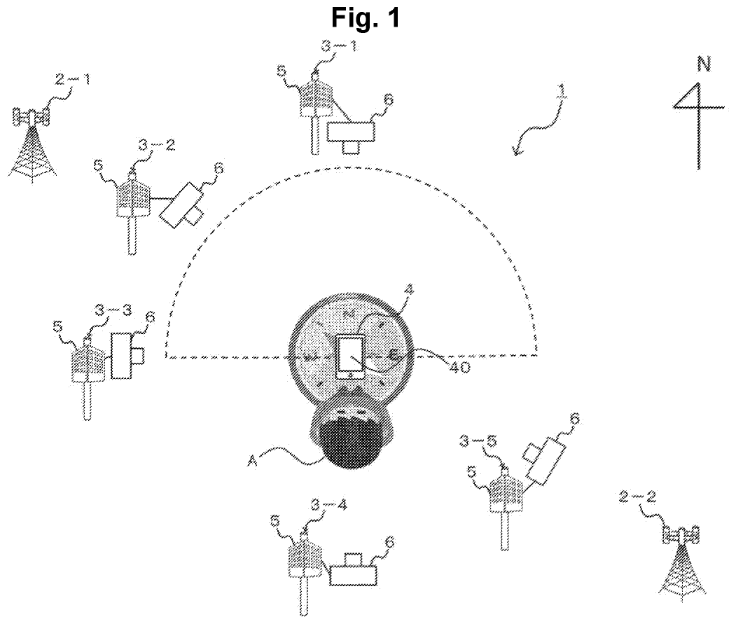

Hereinafter, an embodiment of a wireless communication system will be described with reference to the drawings. FIG. 1 is a diagram schematically illustrating a configuration example of a wireless communication system 1 according to an embodiment. As illustrated in FIG. 1, the wireless communication system 1 includes, for example, two base stations 2-1 and 2-2 and five relay devices 3-1 to 3-5, and enables a human (person) A to perform wireless communication in a high frequency band using a wireless terminal 4.

The wireless terminal 4 is, for example, a smartphone or the like having a display screen 40 on its surface. Further, the wireless terminal 4 can transmit compass information indicating an orientation in which the wireless terminal is directed. For example, the wireless terminal 4 can transmit compass information even when the person A is looking at the display screen 40.

For example, when the person A facing north performs an operation while looking at the display screen 40 in front of the person A, the wireless terminal 4 transmits compass information indicating north. The wireless terminal 4 is configured to then be able to communicate with another communication device via either of the base stations 2-1 and 2-2.

The relay device 3-1 includes a relay unit 5 and an imaging unit 6 to be described later, is installed, for example, on the north side of the wireless terminal 4, and relays the radio waves transmitted by the base station 2-1.

The relay device 3-2 includes a relay unit 5 and an imaging unit 6, is installed, for example, on the northwest side of the wireless terminal 4, and relays the radio waves transmitted by the base station 2-1.

The relay device 3-3 includes a relay unit 5 and an imaging unit 6, is installed, for example, on the west side of the wireless terminal 4, and relays the radio waves transmitted by the base station 2-1.

The relay device 3-4 includes a relay unit 5 and an imaging unit 6, is installed, for example, on the south side of the wireless terminal 4, and relays the radio waves transmitted by the base station 2-2.

The relay device 3-5 includes a relay unit 5 and an imaging unit 6, is installed, for example, on the southeast side of the wireless terminal 4, and relays the radio waves transmitted by the base station 2-2.

For example, the relay devices 3-1 to 3-5 controls a radiation unit (such as a dynamic reflector) including a plurality of elements (such as reflective elements) to relay signals transmitted by the base stations 2-1 and 2-2 toward the wireless terminal 4 and relays signals transmitted by the wireless terminal 4 to the base stations 2-1 and 2-2.

Hereinafter, a case where the wireless terminal 4 itself is at a position where communication with the base station 2-1 can be performed regardless of which of the relay devices 3-1 to 3-3 relays the radio waves transmitted by the base station 2-1, and communication with the base station 2-2 can be performed regardless of which of the relay devices 3-4 and 3-5 relays the radio waves transmitted by the base station 2-2 will be described as an example.

Here, a case where the phases of the reflected radio waves are dynamically controlled will be described as an example, but the relay devices 3-1 to 3-5 may be configured as a relay device that includes a power amplifier and relays the radio waves by a repeater that forms a beam at the time of re-radiation of the received radio waves. Furthermore, the relay devices 3-1 to 3-5 may dynamically control the radiation direction (reflection direction or re-radiation direction) of the radio waves at an arbitrarily set timing.

Note that the radio waves transmitted by the base stations 2-1 and 2-2 are radio waves in a high frequency band that may be blocked by the human body when the person A is present in a propagation path.

Therefore, in the example illustrated in FIG. 1, the wireless terminal 4 can communicate with the base station 2-1 regardless of which of the relay devices 3-1 to 3-3 relays the radio waves transmitted by the base station 2-1, and the radio waves transmitted by the base station 2-2 relayed by the relay devices 3-4 and 3-5 are blocked by the person A. Note that a specific operation example of the wireless communication system 1 will be described later.

Hereinafter, in a case where no single configuration is specified among a plurality of configurations such as the relay devices 3-1 to 3-5, the configuration is simply abbreviated as the relay device 3 or the like.

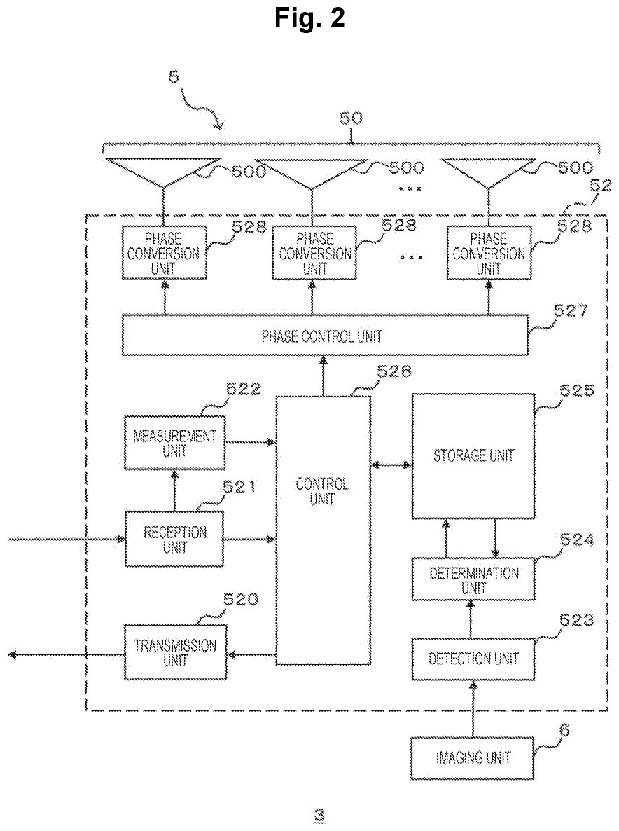

Next, a specific configuration example of each unit constituting the wireless communication system 1 will be described. FIG. 2 is a functional block diagram illustrating functions of the relay device 3. As illustrated in FIG. 2, the relay device 3 includes a relay unit 5 and an imaging unit 6.

The imaging unit 6 is, for example, a camera or the like, captures the surroundings of the relay device 3 as an image, and outputs the captured image to the relay unit 5.

The relay unit 5 includes a radiation unit 50 that forms a beam by making the direction of radiation of radio waves variable, and a relay control unit 52 that controls the radiation unit 50 to relay the radio waves.

The radiation unit 50 includes a plurality of elements 500, and is, for example, a dynamic reflector in which the plurality of elements 500 are arranged in an array. The element 500 reflects the radio waves transmitted by the base station 2 and the radio waves transmitted by the wireless terminal 4 under the control of the relay control unit 52. For example, the element 500 is a so-called metamaterial, and has a characteristic of shifting a phase when reflecting radio waves.

Furthermore, the element 500 may be a repeater that includes a power amplifier and forms a beam by re-radiating the received radio waves. That is, the radiation unit 50 forms a beam in a predetermined direction by each of the plurality of elements 500 radiating radio waves.

The relay control unit 52 includes a transmission unit 520, a reception unit 521, a measurement unit 522, a detection unit 523, a determination unit 524, a storage unit 525, a control unit 526, a phase control unit 527, and a plurality of phase conversion units 528.

The transmission unit 520 transmits radio waves (signals) to the base station 2. For example, the transmission unit 520 transmits line-of-sight information, strength information, and the like to be described later to the base station 2.

The reception unit 521 receives radio waves transmitted by the wireless terminal 4 or the base station 2, and outputs the radio waves to the measurement unit 522 and the control unit 526. For example, the reception unit 521 receives compass information transmitted by the wireless terminal 4, a terminal identification code of the wireless terminal 4, and the like, and stores the compass information, the terminal identification code, and the like in the storage unit 525 via the control unit 526.

For example, the measurement unit 522 measures each of the strengths of the radio waves transmitted by the wireless terminal 4 each time the radiation unit 50 changes the direction in which the radio waves are radiated. Also, the measurement unit 522 stores strength information indicating each of the measured strengths of the radio waves in the storage unit 525 via the control unit 526.

The detection unit 523 acquires an image captured by the imaging unit 6, analyzes and detects the position of a person captured in the image, regards the detected position as, for example, the position of the wireless terminal 4, and outputs the position to the determination unit 524. In addition, the detection unit 523 detects a direction from the relay device 3 (radiation unit 50) to the wireless terminal 4 (propagation path direction information) on the basis of an angle at which the imaging unit 6 images a person or the like.

The determination unit 524 acquires the position of the person (the position information of wireless terminal 4) and the propagation path direction information detected by the detection unit 523 from the detection unit 523, and acquires the compass information transmitted by the wireless terminal 4 from the storage unit 525. Also, the determination unit 524 determines whether or not the propagation path between the radiation unit 50 and the wireless terminal 4 is in a line of sight (LOS) on the basis of the position information, the propagation path direction information, and the compass information of the wireless terminal 4, and outputs line-of-sight information indicating a result of the determination to the storage unit 525.

The storage unit 525 stores the above-described compass information, terminal identification code, position information of the wireless terminal 4, propagation path direction information, strength information, line-of-sight information, and the like, and outputs the stored information under the control of the control unit 526.

The control unit 526 controls each unit constituting the relay device 3. Specifically, the control unit 526 controls the operation of the imaging unit 6, the operation of the radiation unit 50, communication between the relay device 3 and the base station 2, and the like.

The phase control unit 527 controls each of the plurality of phase conversion units 528 so that the radiation unit 50 forms a beam in a direction based on the control of the control unit 526, thereby controlling the phase of the radio waves radiated by each of the plurality of elements 500.

For example, the phase conversion unit 528 is individually provided for each element 500, and performs conversion to change the phase of the radio waves radiated by the element 500 according to the control from the phase control unit 527.

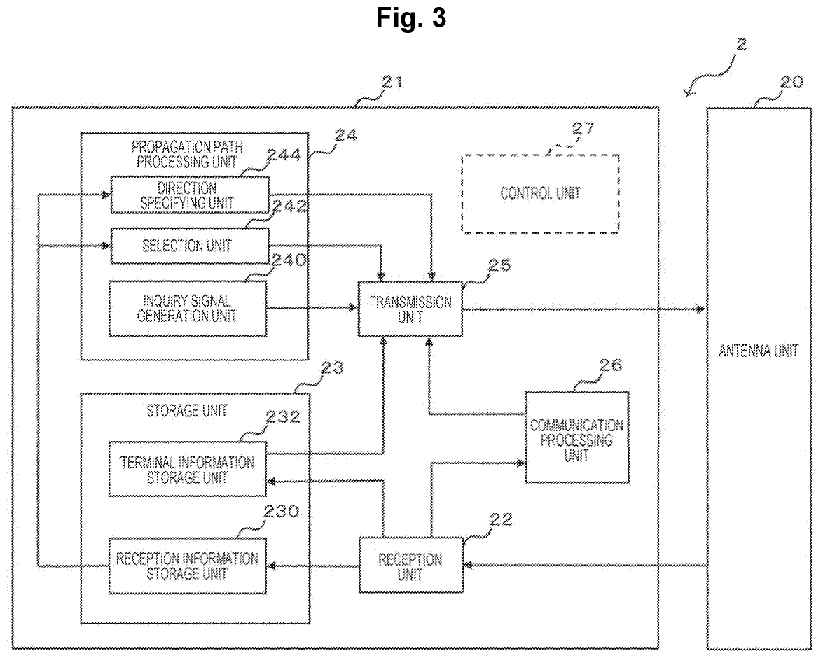

FIG. 3 is a functional block diagram illustrating functions of the base station 2. As illustrated in FIG. 3, the base station 2 includes an antenna unit 20 and a main body unit 21.

The antenna unit 20 includes, for example, a plurality of antennas (not illustrated) and radiates radio waves in a predetermined direction by a phase difference.

The main body unit 21 includes a reception unit 22, a storage unit 23, a propagation path processing unit 24, a transmission unit 25, a communication processing unit 26, and a control unit 27.

The reception unit 22 receives radio waves (signals) transmitted by the relay device 3 and the wireless terminal 4 via the antenna unit 20, and outputs predetermined signals to the storage unit 23 and the communication processing unit 26. For example, the reception unit 22 receives the above-described line-of-sight information and strength information from each of the relay devices 3, a transmission signal (relay signal) to be relayed transmitted by the wireless terminal 4, and the like.

The storage unit 23 includes, for example, a reception information storage unit 230 and a terminal information storage unit 232. The reception information storage unit 230 stores, for example, the line-of-sight information, the strength information, and the like transmitted by the relay device 3, and outputs the line-of-sight information, the strength information, and the like under the control of the control unit 27. The terminal information storage unit 232 stores, for example, terminal identification information and the like transmitted by the wireless terminal 4, and outputs the terminal identification information and the like under the control of the control unit 27.

The propagation path processing unit 24 includes, for example, an inquiry signal generation unit 240, a selection unit 242, and a direction specifying unit 244.

The inquiry signal generation unit 240 generates an inquiry signal used by the relay device 3 to determine whether or not the propagation path is in a line of sight, and outputs the inquiry signal to the transmission unit 25.

The selection unit 242 acquires each piece of line-of-sight information from the reception information storage unit 230, selects the relay device 3 in which the propagation path between the radiation unit 50 and the wireless terminal 4 is in a line of sight on the basis of the line-of-sight information, and outputs the selected result to the transmission unit 25.

In addition, the selection unit 242 may be configured to select the relay device 3 having the shortest distance between the radiation unit 50 and the wireless terminal 4 when there are a plurality of relay devices 3 in which the propagation path between the radiation unit 50 and the wireless terminal 4 is in the line of sight. Furthermore, the selection unit 242 may select the relay device 3 on the basis of the communication quality of uplink communication or downlink communication between the relay device 3 and the wireless terminal 4.

The direction specifying unit 244 acquires each piece of strength information from the reception information storage unit 230, specifies a direction in which the radio waves radiated by the radiation unit 50 are strongest for each relay device 3 on the basis of each piece of strength information, and outputs the specified result to the transmission unit 25.

The transmission unit 25 transmits signals based on the signals input from the storage unit 23, the propagation path processing unit 24, and the communication processing unit 26 via the antenna unit 20.

The communication processing unit 26 performs a communication process for the wireless terminal 4 to communicate with another communication device. For example, the communication processing unit 26 performs processing for acquiring and processing a signal (relay signal) to be relayed transmitted by the wireless terminal 4 via the antenna unit 20 and the reception unit 22 and transmitting the signal via the transmission unit 25 and the antenna unit 20.

The control unit 27 controls each unit constituting the base station 2 to perform control for selecting the relay device 3 that relays a signal to the wireless terminal 4, control for the wireless terminal 4 to communicate with another communication device, and the like. For example, the control unit 27 performs control such that the wireless terminal 4 and the base station 2 perform wireless communication using the radio waves radiated by the relay device 3 selected by the selection unit 242 in the direction specified by the direction specifying unit 244.

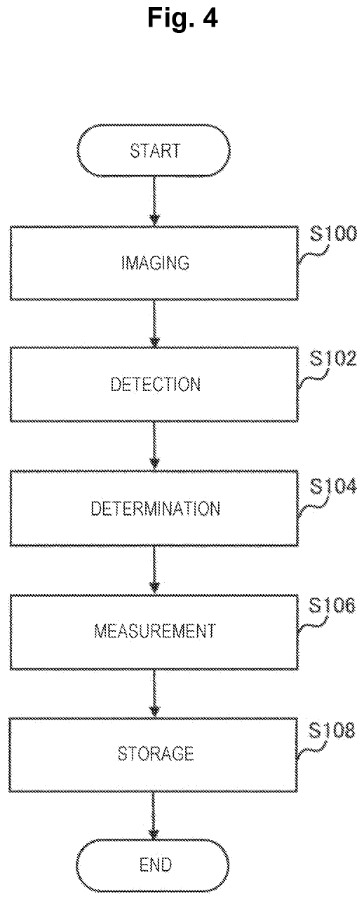

Next, a specific operation example of the wireless communication system 1 will be described. FIG. 4 is a flowchart illustrating an operation example of the relay device 3. Here, it is assumed that the relay device 3 radiates radio waves while changing the radiation direction by the radiation unit 50 at a predetermined timing.

First, as illustrated in FIG. 4, each of the relay devices 3 captures an image (S100), and detects a position of a person captured in the image on the basis of the captured image (S102).

Then, the relay device 3 determines whether or not the propagation path between the radiation unit 50 and the wireless terminal 4 is in a line of sight on the basis of the detected position of the person (position information of the wireless terminal 4) and the compass information transmitted by the wireless terminal 4 (S104).

In addition, each time the radiation unit 50 changes the direction in which the radio waves are radiated, the relay device 3 measures each of the strengths of the radio waves transmitted by the wireless terminal 4 (S106).

In addition, the relay device 3 stores the compass information, the position information of the wireless terminal 4, the strength information, the line-of-sight information, and the like (S108).

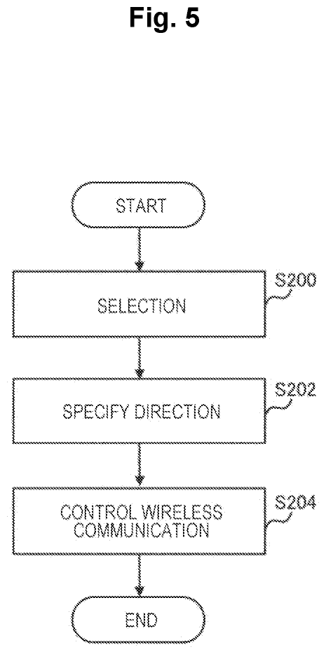

FIG. 5 is a flowchart illustrating an operation example of the base station 2. As illustrated in FIG. 5, the base station 2 selects the relay device 3 in which the propagation path between the radiation unit 50 and the wireless terminal 4 is in a line of sight on the basis of each piece of line-of-sight information received from the relay device 3 (S200).

Further, the base station 2 specifies a direction in which the radio waves radiated by the radiation unit 50 are strongest for each relay device 3 on the basis of each piece of the strength information received from the relay device 3 (S202).

Then, the base station 2 performs control such that the wireless terminal 4 and the base station 2 perform wireless communication using the radio waves radiated by the selected relay device 3 in the specified direction (S204).

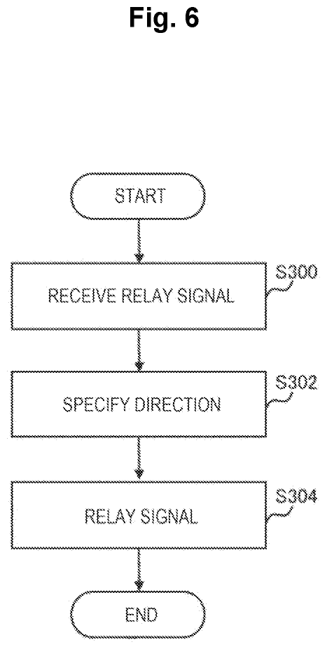

Next, a case where the relay device 3 is a repeater that forms a beam by re-radiating received radio waves will be described. FIG. 6 is a flowchart illustrating an operation example in a case where the relay device 3 is a repeater.

As illustrated in FIG. 6, the relay device 3 receives the relay signal transmitted by the wireless terminal 4 or the base station 2 (S300). Then, the relay device 3 acquires the direction (propagation path direction information) specified by the base station 2 (S302), re-radiates the radio waves in the specified direction, and relays the signal mutually transmitted by the wireless terminal 4 and the base station 2 (S304).

As described above, since the wireless communication system 1 performs control such that the wireless terminal 4 and the base station 2 perform wireless communication using the radio waves radiated by the relay device 3 selected by the base station 2 in the direction specified by the base station 2, it is possible to prevent the human body from blocking radio waves from the wireless terminal 4 used by a person.

Note that some or all of the functions of the base station 2 and the relay device 3 may be configured by hardware such as a programmable logic device (PLD) or a field programmable gate array (FPGA), or may be configured as a program executed by a processor such as a CPU.

For example, the relay device 3 according to the present invention can be implemented by using a computer and a program, and the program can be recorded in a storage medium or provided through a network.

### REFERENCE SIGNS LIST

1 Wireless communication system
2-1, 2-2 Base station
3-1 to 3-5 Relay device
4 Wireless terminal
5 Relay unit
6 Imaging unit
20 Antenna unit
21 Main body unit
22 Reception unit
23 Storage unit
24 Propagation path processing unit
25 Transmission unit
26 Communication processing unit
27 Control unit
40 Display screen
50 Radiation unit
52 Relay control unit
230 Reception information storage unit
232 Terminal information storage unit
240 Inquiry signal generation unit
242 Selection unit
244 Direction specifying unit
500 Element
520 Transmission unit
521 Reception unit
522 Measurement unit
523 Detection unit
524 Determination unit
525 Storage unit
526 Control unit
527 Phase control unit
528 Phase conversion unit

1. A wireless communication method in which a plurality of relay devices relay radio waves transmitted by a base station toward a wireless terminal capable of transmitting compass information while a person is looking at a display screen, the wireless communication method comprising:
a radiation step in which each of the relay devices radiates radio waves while changing a radiation direction of the radio waves with a radiation unit configured to make the radiation direction variable;
an imaging step of capturing an image by each of the relay devices;
a detection step of detecting a position of a person captured in the image on the basis of the image captured by each of the relay devices;
a determination step of determining whether or not a propagation path between the radiation unit and the wireless terminal is in a line of sight on the basis of the detected position of the person and the compass information transmitted by the wireless terminal;
a measurement step of measuring each of strengths of radio waves transmitted by the wireless terminal each time the radiation unit changes a direction in which the radio waves are radiated;
a selection step of selecting the relay device in which the propagation path between the radiation unit and the wireless terminal is in the line of sight on the basis of each piece of line-of-sight information indicating a result of the determination;
a direction specifying step of specifying, for each of the relay devices, a direction in which radio waves radiated by the radiation unit are strongest on the basis of each piece of strength information indicating each of measured strengths of radio waves; and
a control step of performing control such that the wireless terminal and the base station perform wireless communication using radio waves radiated by the selected relay device in the specified direction.

2. The wireless communication method according to claim 1, wherein the selection step includes selecting the relay device having a shortest distance between the radiation unit and the wireless terminal when there are a plurality of the relay devices in which the propagation path between the radiation unit and the wireless terminal is in the line of sight.

3. A wireless communication system in which a plurality of relay devices relay radio waves transmitted by a base station toward a wireless terminal capable of transmitting compass information while a person is looking at a display screen, wherein
each of the relay devices includes:
a radiation unit configured to make a direction in which radio waves are radiated variable;
an imaging unit configured to capture an image;
a detection unit configured to detect a position of a person captured in the image on the basis of the image captured by the imaging unit;
a determination unit configured to determine whether or not a propagation path between the radiation unit and the wireless terminal is in a line of sight on the basis of the position of the person detected by the detection unit and the compass information transmitted by the wireless terminal;
a measurement unit configured to measure each of strengths of radio waves transmitted by the wireless terminal each time the radiation unit changes the direction in which the radio waves are radiated; and
a transmission unit configured to transmit, to the base station, line-of-sight information indicating a result determined by the determination unit and strength information indicating each of the strengths of the radio waves measured by the measurement unit, and
the base station includes:
a reception unit configured to receive the line-of-sight information and the strength information from each of the relay devices;
a selection unit configured to select the relay device in which the propagation path between the radiation unit and the wireless terminal is in the line of sight on the basis of each piece of the line-of-sight information received by the reception unit;
a direction specifying unit configured to specify, for each of the relay devices, a direction in which radio waves radiated by the radiation unit are strongest on the basis of each piece of the strength information received by the reception unit; and
a control unit configured to perform control such that the wireless terminal and the base station perform wireless communication using radio waves radiated by the relay device selected by the selection unit in the direction specified by the direction specifying unit.

4. The wireless communication system according to claim 3, wherein the selection unit selects the relay device having a shortest distance between the radiation unit and the wireless terminal when there are a plurality of the relay devices in which the propagation path between the radiation unit and the wireless terminal is in the line of sight.

5. A relay device that relays radio waves transmitted by a base station toward a wireless terminal capable of transmitting compass information while a person is looking at a display screen, the relay device comprising:
a radiation unit configured to make a direction in which radio waves are radiated variable;
an imaging unit configured to capture an image;
a detection unit configured to detect a position of a person captured in the image on the basis of the image captured by the imaging unit;
a determination unit configured to determine whether or not a propagation path between the radiation unit and the wireless terminal is in a line of sight on the basis of the position of the person detected by the detection unit and the compass information transmitted by the wireless terminal;
a measurement unit configured to measure each of strengths of radio waves transmitted by the wireless terminal each time the radiation unit changes the direction in which the radio waves are radiated; and
a transmission unit configured to transmit, to the base station, line-of-sight information indicating a result determined by the determination unit and strength information indicating each of the strengths of the radio waves measured by the measurement unit.
